(19) United States
(12) Patent Application Publication
(10) Pub. No.: US 2025/0063629 A1
(43) Pub. Date: Feb. 20, 2025

(54) MONITORING A PDCCH PROVIDING A NETWORK OPERATION STATE

(71) Applicant: Samsung Electronics Co., Ltd., Suwon-si (KR)

(72) Inventors: Jeongho Jeon, San Jose, CA (US); Aristides Papasakellariou, Houston, TX (US)

(21) Appl. No.: 18/793,644

(22) Filed: Aug. 2, 2024

Related U.S. Application Data
(60) Provisional application No. 63/533,452, filed on Aug. 18, 2023.
(60) Provisional application No. 63/539,744, filed on Sep. 21, 2023.

(51) Int. Cl. H04W 76/28

(52) U.S. Cl. CPC H04W 76/28

(57) ABSTRACT

Apparatuses and methods for monitoring of a physical downlink control channel (PDCCH) providing a network operation state. A method performed by a user equipment (UE) receiving first information related to one or more sets of parameters associated with respective one or more cell discontinuous transmission (DTX) or cell discontinuous reception (DRX) configurations on a cell, receiving second information related to a reception of an indication for activation or deactivation of the cell DTX or the cell DRX and receiving the indication. The sets of parameters include periodicity, start offset, and an on-duration timer. The method further includes determining an active period and an inactive period of the cell DTX or cell DRX based on the indication and the first information or an active period and receiving or transmitting channels or signals on the cell based on the determined active and inactive periods of the cell DTX or the cell DRX.

### CROSS-REFERENCE TO RELATED AND CLAIM OF PRIORITY

The present application claims priority under 35 U.S.C. § 119(e) to U.S. Provisional Patent Application No. 63/533,452 filed on Aug. 18, 2024, and U.S. Provisional Patent Application No. 63/539,744 filed on Sep. 21, 2023, which are hereby incorporated by reference in their entirety.

### TECHNICAL FIELD

The present disclosure relates generally to wireless communication systems and, more specifically, the present disclosure is related to apparatuses and methods for monitoring of a physical downlink control channel (PDCCH) providing a network operation state.

### BACKGROUND

The present disclosure relates generally to wireless communication systems and, more specifically, to procedures for enabling network energy savings. Network energy savings is important for environmental sustainability, to reduce environmental impact (greenhouse gas emissions), and for operational cost savings. With the wireless communications industry projected to potentially contribute as much as 20% of the global energy consumption by 2030, communications networks must be attentive to global priorities pertaining to climate change, especially the reduction of energy consumption. Also, energy consumption has become a key part of the operators' OPEX. According to the report from GSMA, the energy cost on mobile networks accounts for ˜23% of the total operator cost. Most of the energy consumption occurs at the radio access network and in particular at the Active Antenna Unit (AAU), with data centers and fiber transport accounting for a smaller share. The energy consumption for radio access can be split into two parts: a dynamic part that occurs only when data transmission/reception is active, and a static part that always occurs in order to maintain the necessary operation of the radio access devices, even when data transmission/reception is not active.

As 5G is becoming pervasive across industries and geographical areas, handling more advanced services and applications requiring very high data rates (e.g., XR), networks are being denser, use more antennas, larger bandwidths and more frequency bands. For example, network densification increases the number of transmission points, higher carrier frequencies lend themselves to larger numbers of antennas, and for the case of higher spectrum bands, e.g., mmW or sub-THz/THz spectrum, the frequencies of operation trend towards wider bandwidths resulting in worse impairment characteristics for RF electronics along with higher sampling rates for digital processes and data converters. High clock rates demand power consumption that increases approximately with linear proportionality. This trend will continue in 6G. Therefore, the environmental impact of 5G as well as future 6G needs to stay under control, and novel solutions to improve network energy savings need to be developed. These solutions could allow to achieve more efficient operation dynamically and/or semi-statically and finer granularity adaptation of transmissions and/or receptions in one or more of network energy savings techniques in time, frequency, spatial, and power domains, with potential support/feedback from UE, potential UE assistance information, and information exchange/coordination over network interfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to apparatuses and methods for monitoring of a PDCCH providing a network operation state.

In one embodiment, a method performed by a user equipment (UE) is provided. The method includes receiving first information related to one or more sets of parameters associated with respective one or more cell discontinuous transmission (DTX) or cell discontinuous reception (DRX) configurations on a cell; second information related to a reception of an indication for activation or deactivation of the cell DTX or the cell DRX from the one or more cell DTX or cell DRX configurations; and the indication based on the second information. The one or more sets of parameters include a periodicity, a start offset, and an on-duration timer. The method further includes determining one of an active period and an inactive period of the cell DTX based on the indication and the first information or an active period and an inactive period of the cell DRX based on the indication and the first information; and one of receiving channels or signals on the cell based on the determined active and inactive periods of the cell DTX or transmitting channels or signals on the cell based on the determined active and inactive periods of the cell DRX.

In another embodiment, a UE is provided. The UE includes a transceiver configured to receive first information related to one or more sets of parameters associated with respective one or more cell DTX or DRX configurations on a cell; second information related to a reception of an indication for activation or deactivation of the cell DTX or the cell DRX from the one or more cell DTX or cell DRX configurations; and the indication based on the second information. The one or more sets of parameters include a periodicity, a start offset, and an on-duration timer. The UE further includes a processor operably coupled to the transceiver. The processor is configured to determine one of an active period and an inactive period of the cell DTX based on the indication and the first information or an active period and an inactive period of the cell DRX based on the indication and the first information. The transceiver is further configured to one of receive channels or signals on the cell based on the determined active and inactive periods of the cell DTX or transmit channels or signals on the cell based on the determined active and inactive periods of the cell DRX.

In yet another embodiment, a base station (BS) is provided. The BS includes a transceiver configured to transmit first information related to one or more sets of parameters associated with respective one or more cell DTX or cell DRX configurations on a cell; second information related to a transmission of an indication for activation or deactivation of the cell DTX or the cell DRX from the one or more cell DTX or cell DRX configurations; and the indication based on the second information. The one or more sets of parameters include a periodicity, a start offset, and an on-duration timer. The BS further includes a processor operably coupled to the transceiver. The processor is configured to determine one of an active period and an inactive period of the cell DTX based on the indication and the first information or an active period and an inactive period of the cell DRX based on the indication and the first information. The transceiver is further configured to one of transmit channels or signals on the cell based on the determined active and inactive periods of the cell DTX or receive channels or signals on the cell based on the determined active and inactive periods of the cell DRX.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIGS. 6A and 6B illustrate an example of a transmitter and receiver structures using orthogonal frequency division multiplexing (OFDM) according to embodiments of the present disclosure;

FIGS. 7 and 8 illustrate a flow diagram of an encoding and decoding processes for downlink control information (DCI), respectively, according to embodiments of the present disclosure;

FIGS. 9A and 9B illustrate timelines for example cell discontinued transmissions (DTX) and cell discontinued receptions (DRX) according to embodiments of the present disclosure;

FIG. 10 illustrates diagrams of example spatial domain (SD) adaptations according to embodiments of the present disclosure;

FIG. 11 illustrates an example cell DTX/DRX activation/deactivation on a cell using DCI format 2_9 according to embodiments of the present disclosure;

FIG. 12 illustrates an example flowchart of a method for adapting operation states on a cell using DCI format 2_9 according to embodiments of the present disclosure;

FIG. 13A illustrates an example UE PDCCH monitoring behavior for receiving DCI format 2_9 during Cell DTX/DRX deactivated period as an example operation state on a cell according to embodiments of the present disclosure;

FIG. 13B illustrates an example DCI format 2_9 monitoring occasions when Cell DTX/DRX is activated on a cell according to embodiments of the present disclosure;

FIG. 13C illustrates an example of an underlying Cell DTX/DRX pattern and an activated pattern with DCI format 2_9 according to embodiments of the present disclosure;

FIG. 14 illustrates an example UE PDCCH monitoring behavior 1400 for receiving DCI format 2_9 during Cell DTX/DRX on-duration on a cell according to embodiments of the present disclosure;

FIG. 15 illustrates an example UE PDCCH monitoring behavior 1500 for receiving DCI format 2_9 during Cell DTX/DRX off-duration on a cell according to embodiments of the present disclosure; and

FIG. 16 illustrates an example flowchart for a method for monitoring PDCCH providing DCI format 2_9 in RRC INACTIVE/IDLE state according to embodiments of the present disclosure.

### DETAILED DESCRIPTION

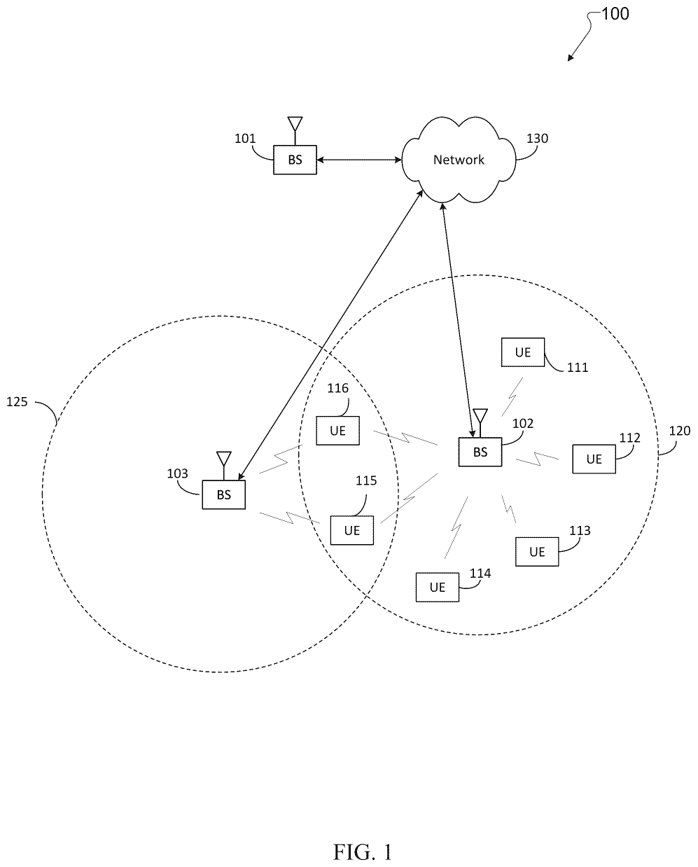

FIGS. 1-16, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v17.5.0, “NR; Physical channels and modulation;” [REF2] 3GPP TS 38.212 v17.5.0, “NR; Multiplexing and channel coding;” [REF3] 3GPP TS 38.213 v17.6.0, “NR; Physical layer procedures for control;” [REF4] 3GPP TS 38.214 v17.6.0, “NR; Physical layer procedures for data;” [REF5] 3GPP TS 38.215 v17.5.0, “NR; Physical layer measurements;” and [REF6] 3GPP TS 38.321 v17.5.0, “NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally regarded as a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for monitoring of a PDCCH providing a network operation state. In certain embodiments, one or more of the BSs 101-103 include circuitry, programing, or a combination thereof to provide a PDCCH providing a network operation state.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

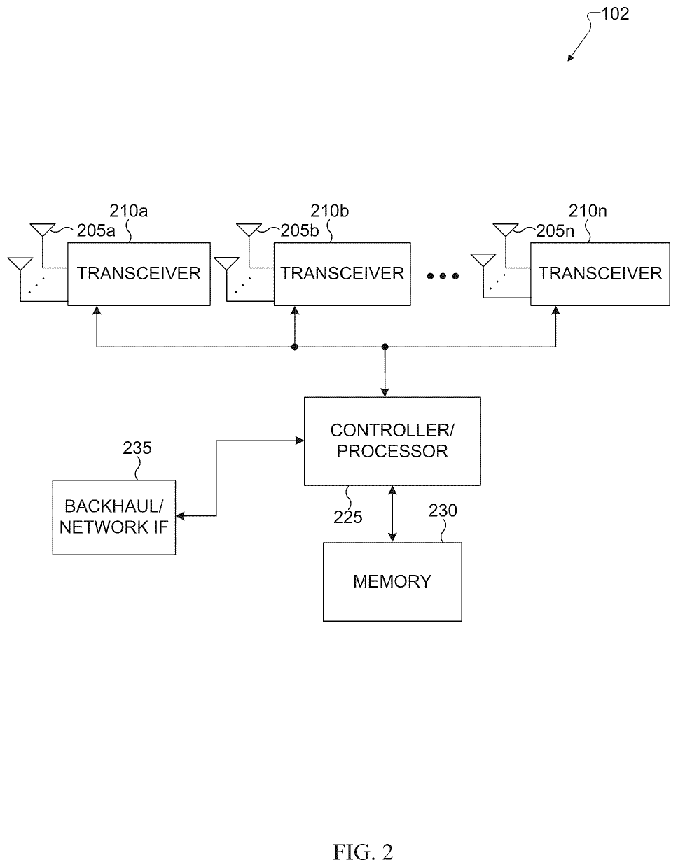

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for providing a PDCCH providing a network operation state. Any of a wide variety of other functions could be supported in the gNB 102 by the controller/processor 225.

The controller/processor 225 is also capable of executing programs and other processes resident in the memory 230, such as processes for supporting monitoring of a PDCCH providing a network operation state. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

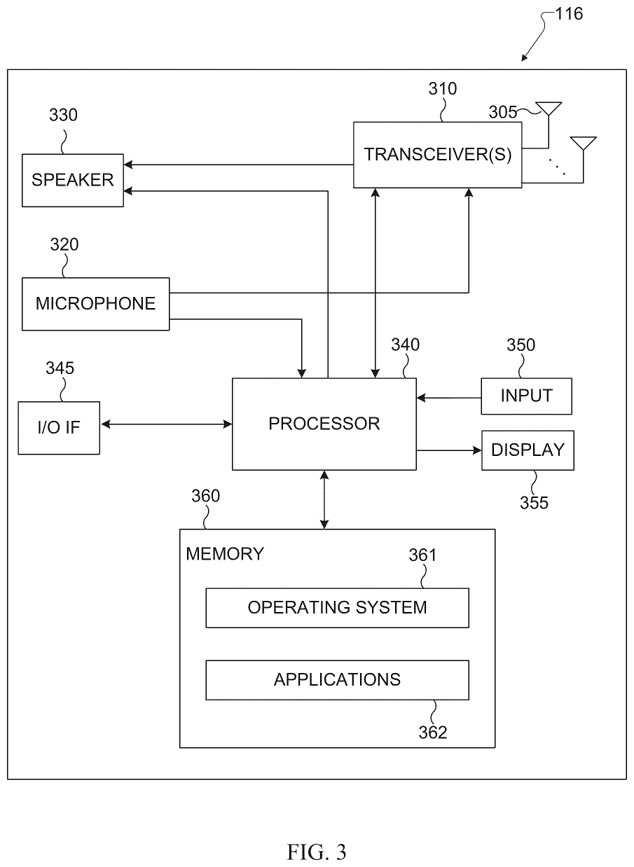

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for monitoring of a PDCCH providing a network operation state as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

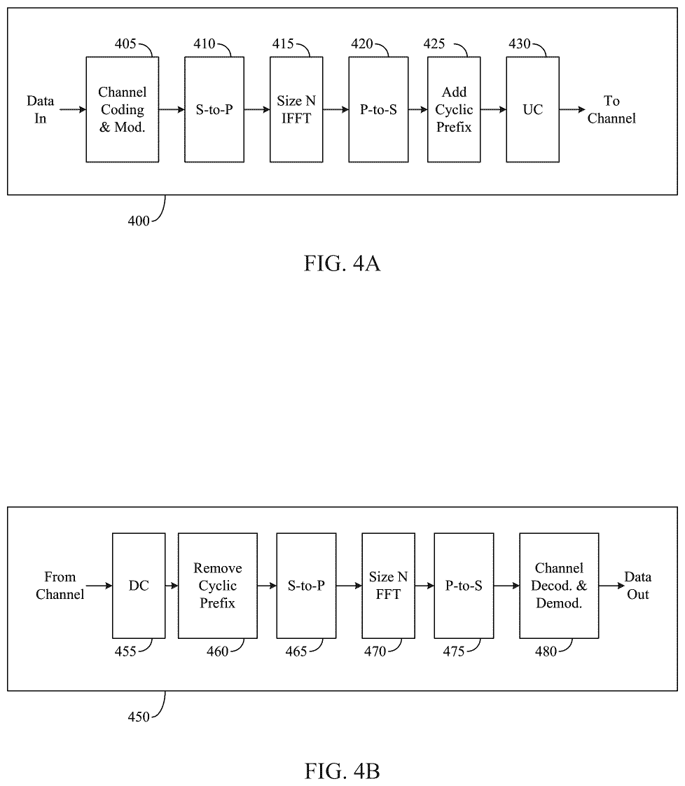

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for monitoring of a PDCCH providing a network operation state as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

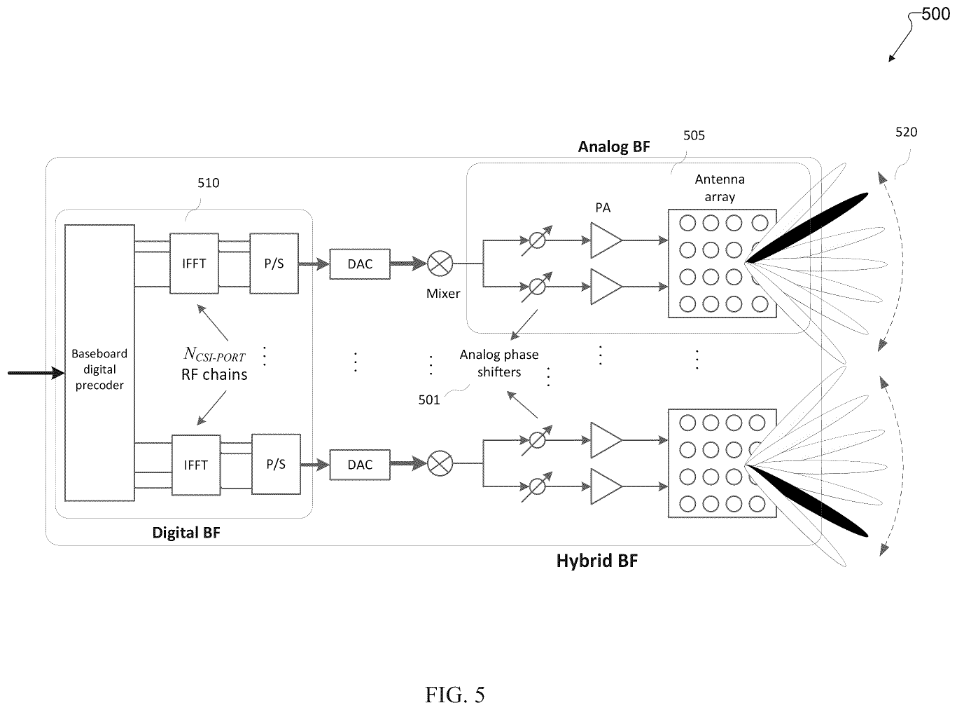

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments evaluate a same numerology, which includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v17.5.0, “NR; Physical channels and modulation”, and 3GPP TS 38.213 v17.6.0 “NR; Physical Layer procedures for control”.

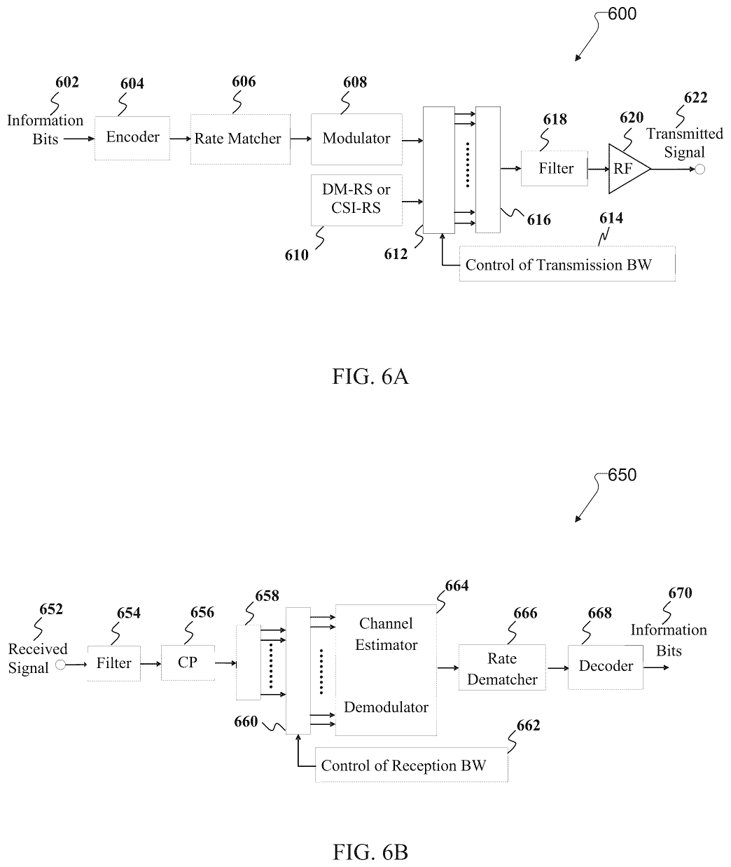

FIGS. 6A and 6B illustrate an example of transmitter and receiver structures 600 and 650, respectively, using OFDM according to embodiments of the present disclosure. For example, a transmit structure 600 may be described as being implemented in a gNB (such as gNB 102), while a receive structure 650 may be described as being implemented in a UE (such as UE 116). This example is for illustration only and other embodiments can be used without departing from the scope of the present disclosure.

Information bits, such as DCI bits or data bits 602, are encoded by encoder 604, rate matched to assigned time/frequency resources by rate matcher 606 and modulated by modulator 608. Subsequently, modulated encoded symbols and DM-RS or CSI-RS 610 are mapped to REs 612 by RE mapping unit 614, an inverse fast Fourier transform (IFFT) is performed by filter 616, a cyclic prefix (CP) is added by CP insertion unit 618, and a resulting signal is filtered by filter 620 and transmitted by a radio frequency (RF) unit 622.

A received signal 652 is filtered by filter 654, a CP removal unit removes a CP 656, a filter 658 applies a fast Fourier transform (FFT), RE de-mapping unit 660 de-maps REs selected by BW selector unit 662, received symbols are demodulated by a channel estimator and a demodulator unit 664, a rate de-matcher 666 restores a rate matching, and a decoder 668 decodes the resulting bits to provide information bits 670.

DCI can serve several purposes. A DCI format includes a number of fields, or information elements (IEs), and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with radio resource control (RRC) connection to a gNB, the RNTI is a cell RNTI (C-RNTI) or another RNTI type such as a modulation and coding scheme (MCS)-C-RNTI. For a DCI format scheduling a PDSCH conveying system information (SI) to a group of UEs, the RNTI is a SI-RNTI. For a DCI format scheduling a PDSCH providing a response to a random access (RA) from a group of UEs, the RNTI is a RA-RNTI. For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a Transmit Power Control (TPC)-RNTI, and so on. Each RNTI type is configured to a UE through higher layer signaling. A UE typically decodes at multiple candidate locations for potential PDCCH receptions as determined by an associated search space set.

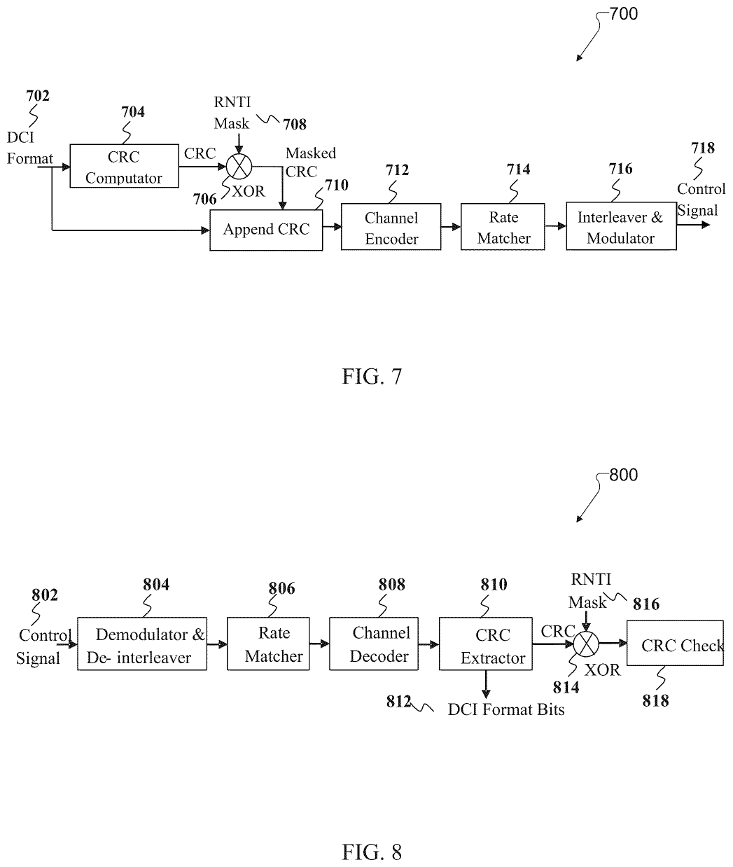

FIGS. 7 and 8 illustrate an example of an encoding and decoding processes 700 and 800, respectively, for DCI according to embodiments of the present disclosure. For example, encoding process 700 may be implemented by a BS 102 while decoding process 800 may be implemented by any of the UEs 111-116 of FIG. 1. This example is for illustration only and other embodiments can be used without departing from the scope of the present disclosure.

A gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 24 bits and the RNTI can include 16 bits or 24 bits. The CRC of (non-coded) DCI format bits 702 is determined using a CRC computation unit 704, and the CRC is masked using an exclusive OR (XOR) operation unit 706 between CRC bits and RNTI bits 708. The XOR operation is defined as XOR(0,0)=0, XOR(0,1)=1, XOR(1,0)=1, XOR(1,1)=0. The masked CRC bits are appended to DCI format information bits using a CRC append unit 710. An encoder 712 performs channel coding, such as polar coding, followed by rate matching to allocated resources by rate matcher 714. Interleaving and modulation units 716 apply interleaving and modulation, such as QPSK, and the output control signal 718 is transmitted.

A received control signal 802 is demodulated and de-interleaved by a demodulator and a de-interleaver 804. A rate matching applied at a gNB transmitter is restored by rate matcher 806, and resulting bits are decoded by decoder 808. After decoding, a CRC extractor 810 extracts CRC bits and provides DCI format information bits 812. The DCI format information bits are de-masked 814 by an XOR operation with a RNTI 816 (when applicable) and a CRC check is performed by unit 818. When the CRC check succeeds (check-sum is zero), the DCI format information bits are regarded to be valid. When the CRC check does not succeed, the DCI format information bits are regarded to be invalid.

For each DL bandwidth part (BWP) indicated to a UE in a serving cell, the UE (e.g., the UE 116) can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, CCE-to-resource element groups (REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF2] v17.5.0, or for DCI formats associated with scheduling broadcast/multicast PDSCH receptions, and for DCI format 0_0 and DCI format 1_0.

A set of PDCCH candidates for a UE to monitor is defined in terms of PDCCH search space sets. A search space set can be a CSS set or a USS set. A UE monitors PDCCH candidates in one or more of the following search spaces sets
a Type0-PDCCH CSS set on the primary cell of the MCG configured by:
   pdcch-ConfigSIB1 in MIB or by searchSpaceSIB1 in PDCCH-ConfigCommon or by searchSpaceZero in PDCCH-ConfigCommon for a DCI format 1_0 with CRC scrambled by a SI-RNTI, or
   searchSpaceZero by providing searchSpaceID=0 for searchSpaceMCCH or searchSpaceMTCH for a DCI format 4_0 with CRC scrambled by a MCCH-RNTI or a G-RNTI for broadcast;
a Type0A-PDCCH CSS set configured by searchSpaceOtherSystemInformation in PDCCH-ConfigCommon for a DCI format 1_0 with CRC scrambled by a SI-RNTI on the primary cell of the MCG;
a Type0B-PDCCH CSS set configured by searchSpaceMCCH and searchSpaceMTCH for a DCI format 4_0 with CRC scrambled by a MCCH-RNTI or a G-RNTI for broadcast, on the primary cell of the MCG;
a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell;
a Type1A-PDCCH CSS set configured by sdt-SearchSpace in PDCCH-ConfigCommon for a DCI format with CRC scrambled by a C-RNTI or a CS-RNTI on the primary cell as described in clause 19.1;
a Type2-PDCCH CSS set configured by pagingSearchSpace in PDCCH-ConfigCommon for a DCI format 1_0 with CRC scrambled by a P-RNTI on the primary cell of the MCG;
a Type2A-PDCCH CSS set configured by pei-SearchSpace in pei-ConfigBWP for a DCI format 2_7 with CRC scrambled by a PEI-RNTI on the primary cell of the MCG;
a Type3-PDCCH CSS set configured by:
   SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI and, only for the primary cell, C-RNTI, MCS-C-RNTI, CS-RNTI(s), or PS-RNTI, or
   SearchSpace in pdcch-ConfigMulticast for DCI formats with CRC scrambled by G-RNTI, or G-CS-RNTI, or
   searchSpaceMCCH and searchSpaceMTCH on a secondary cell for a DCI format 4_0 with CRC scrambled by a MCCH-RNTI or a G-RNTI for broadcast, and
a USS set configured by:
   SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL Semi-Persistent Scheduling V-RNTI.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ)mod kₛ=0. The UE monitors PDCCH candidates for search space set s for Tₛ consecutive slots, starting from slot n_{s,f}^{μ}, and does not monitor PDCCH candidates for search space set s for the next kₛ-Tₛ consecutive slots. The UE determines CCEs for monitoring PDCCH according to a search space set based on a search space equation as described in TS 38.213 [REF3] v17.6.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 [REF2] v17.6.0, so that the DCI size limit would not be exceeded.

For each scheduled cell, the UE is not required to monitor on the active DL BWP with SCS configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot, wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{totol,slot,μ} and C_{PDCCH}^{total,slot,μ} are respectively a total number of PDCCH candidates and non-overlapping CCEs for a scheduling cell, as described in TS 38.213 [REF3] v17.6.0.

A UE does not expect to be configured CSS sets, other than CSS sets for multicast PDSCH scheduling, which result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the aforementioned limits/maximum per slot for scheduling on the primary cell, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3] v17.6.0.

For same cell scheduling or for cross-carrier scheduling where a scheduling cell and scheduled cells have DL BWPs with same SCS configuration μ, a UE does not expect a number of PDCCH candidates. A number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 v17.6.0 and TS 38.214 [REF4] v17.6.0.

MIMO technologies have a key role in boosting system throughput both in NR and LTE and such a role will continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

For mmWave bands, although a number of antenna elements can be larger than in lower bands for a given form factor, a number of CSI-RS ports, that can correspond to a number of digitally precoded ports, tends to be limited due to hardware constraints (such as the feasibility to install a large number of ADCs/DACs at mmWave frequencies) as illustrated in FIG. 8. In this case, one CSI-RS port is mapped onto a large number of antenna elements which can be controlled by a bank of analog phase shifters. One CSI-RS port can then correspond to one sub-array that produces a narrow analog beam through analog beamforming. This analog beam can be configured to sweep across a wider range of angles by varying the phase shifter bank across symbols, slots, or subframes. The number of sub-arrays (equal to the number of RF chains) is same as the number of CSI-RS ports N_{CSI-PORT}. A digital beamforming unit performs a linear combination across N_{CSI-PORT} analog beams to further increase precoding gain. While analog beams are wideband, and therefore are not frequency-selective, digital precoding can be varied across frequency sub-bands or resource blocks.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) ‘CLASS A’ CSI reporting that corresponds to non-precoded CSI-RS, 2) ‘CLASS B’ CSI reporting with K=1 CSI-RS resource that corresponds to UE-specific beamformed CSI-RS, and 3) ‘CLASS B’ reporting with K>1 CSI-RS resources that corresponds to cell-specific beamformed CSI-RS. For non-precoded (NP) CSI-RS, a cell-specific one-to-one mapping between CSI-RS port and transmission rate unit (TXRU) is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and, hence, do not provide cell-wide coverage and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB (e.g., the gNB 102) to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For multi-user (MU)-MIMO, in particular, availability of accurate CSI is necessary in order to guarantee robust MU performance and avoid interference among transmissions to different UEs. For time division duplexing (TDD) systems, CSI can be acquired using SRS transmissions from UEs by relying on DL/UL channel reciprocity. For frequency division duplexing (FDD) systems, a gNB can acquire CSI by transmitting CSI-RS and obtaining corresponding CSI reports from UEs. A CSI reporting framework can be ‘implicit’ in the form of channel quality indicator (CQI)/precoding matrix indicator (PMI)/rank indicator (RI), and CSI-RS resource indicator (CRI), as derived from a codebook expecting SU transmission from eNB. Because of the inherent SU expectation while deriving CSI, implicit CSI feedback is inadequate for MU transmissions. For MU-centric operation, a high-resolution Type-II codebook, in addition to low resolution Type-I codebook, can be used. CSI refers to any of CRI, RI, LI, PMI, CQI, RSRP, or SINR.

A serving gNB (such as the BS 102) can configure Type-I and Type-II CSI codebooks to a UE using higher layer signalling to provide a CodebookConfig IE, as described in TS 38.331 [REF5] v17.5.0, that includes the following parameters.
codebookType includes type1, type2 and sub-types such as type1-SinglePanel, type1-MultiPanel, typeII, and typeII-PortSelection, and corresponding parameters for each type.
n1-n2 configures a number of antenna ports in first (n1) and second (n2) dimension and codebook subset restriction for typeI-SinglePanel.
ng-n1-n2 configures a number of antenna panels (ng), a number of antenna ports in first (n1) and second (n2) dimension expecting that the antenna structure is identical for the configured number of panels, and a codebook subset restriction for Type I Multi-panel codebook.
n1-n2-codebookSubsetRestriction configures a number of antenna ports in first (n1) and second (n2) dimension and a codebook subset restriction for typeII.
CodebookConfig-r17 includes typeI-SinglePanel1-r17 and typeI-SinglePanel2-r17 for type1 to enable configuration of different antenna structures for two TRPs.

The IE RS-ResourceMapping indicates a resource element mapping for a CSI-RS resource in the time and frequency domains. The container of the IE includes elements for configuration of time domain resources such as by and frequency firstOFDMSymbolInTimeDomain, firstOFDMSymbolInTimeDomain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to a UE parameters for providing a periodic or semi-persistent CSI report via physical uplink control channel (PUCCH) transmissions on the cell where CSI-ReportConfig is included, or to indicate parameters for providing a semi-persistent or aperiodic CSI report on a PUSCH as triggered by a DCI that the UE receives. The CSI-ReportConfig is set for certain CSI-ResourceConfigId for channel/interference measurements. The aforementioned CodebookConfig is also part of CSI-ReportConfig.

For aperiodic CSI, both aperiodic CSI reporting and aperiodic CSI-RS transmission are triggered using a ‘CSI Request’ field within a DCI format scheduling a PUSCH transmission, such as DCI format 0_1. The ‘CSI Request’ field indicates a ‘Trigger State’ that points to a certain CSI-ReportConfigId and resourcesForChannel, e.g., NZP-CSI-RS-ResourceSet. The ‘CSI Request’ field can have up to 6 bits and can indicate up to 64 ‘Trigger States’. If a UE is configured with more than 64 ‘Trigger States’, a ‘Aperiodic CSI Trigger State Subselection’ MAC control element (CE) identifies a subset of Trigger States that are indicated by DCI.

For semi-persistent CSI (SP CSI-RS) on PUCCH, the semi-persistent CSI-RS resource is triggered by a “SP CSI-RS/CSI interference measurement (CSI-IM) Resource Set Activation/Deactivation” MAC CE that includes a SP CSI-RS resource set ID indicating an index of NZP-CSI-RS-ResourceSet containing Semi Persistent NZP CSI-RS resources indicating the Semi Persistent NZP CSI-RS resource set that is to be activated or deactivated. Semi-persistent CSI reporting on PUCCH is triggered using the “SP CSI reporting on PUCCH Activation/Deactivation” MAC CE. The field Sᵢ in the MAC CE indicates the activation/deactivation status of the Semi-Persistent CSI report configuration within csi-ReportConfigToAddModList. S₀ refers to the report configuration that includes PUCCH resources for semi-persistent CSI reporting in the indicated BWP and has the lowest CSI-ReportConfigId within the list with type set to semiPersistentOnPUCCH. S₁ refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a ‘CSI Request’ field in a DCI format 0_1 with CRC scrambled by a semi-persistent CSI-RNTI (SP-CSI-RNTI). The operating details are similar to those for an aperiodic CSI report.

For periodic CSI reporting, both reporting and periodic CSI-RS resources are configured and initiated by CSI-ReportConfig.

Embodiments of the present disclosure recognize that present networks have limited capability to adapt an operation state in one or more of time/frequency/spatial/power domains. For example, in NR, there are transmissions or receptions on a cell by a serving gNB that are expected by UEs, such as transmissions of synchronization signals/physical broadcast channel (SS/PBCH) blocks, or of system information, or of CSI-RS indicated by higher layers, or receptions of physical random access channel (PRACH) or sounding reference signal (SRS) indicated by higher layers. Reconfiguration of a network (NW) operation state involves higher layer signaling by a system information block (SIB) or by UE-specific RRC. That is a slow process and requires substantial signaling overhead, particularly for UE-specific RRC signaling. For example, it is currently not practical or possible for a network in typical deployments to enter an energy saving operation state where the network (e.g., the network 130) does not transmit or receive due to low traffic on a cell as, in order to obtain material energy savings, the network needs to suspend transmissions or receptions for several tens of milliseconds and preferably for even longer time periods. A similar inability exists for suspending transmission or receptions on a cell for shorter time periods as a serving gNB may need to frequently transmit SS/PBCH blocks on the cell, such as every 5 msec or every 20 msec and, in time division duplex (TDD) systems with UL-DL configurations having few UL symbols in a period, the serving gNB may need to receive PRACH or SRS on the cell in most UL symbols in a period.

Due to the reasons herein, adaptation of a NW operation state on a cell is typically over long time periods, such as for off-peak hours when an amount of served traffic is small and for peak hours when an amount of served traffic is large. Therefore, a capability of a gNB to improve service by fast adaptation of a NW operation state to the traffic types and load on a cell, or to save energy by switching to an operation state that requires less energy consumption when an impact on service quality would be limited or none on a cell, is currently limited as there are no procedures for a serving gNB to perform fast adaptation of a NW operation state with small signaling overhead while simultaneously informing UEs of the NW operation state for a cell.

Embodiments of the present disclosure recognize that is also beneficial to support a gradual transition of NW operation states on a cell between a maximum state where the cell operates at its maximum capability in one or more of a time/frequency/spatial/power domain and a minimum state where the cell operates at its minimum capability, or the cell enters a sleep mode. That would allow continuation of service while the cell transitions from a state with larger utilization of time/frequency/spatial/power resources to a state with lower utilization of such resources and the reverse as UEs can obtain time/frequency synchronization and AGC alignments, perform measurements, and provide CSI reports or transmit SRS prior to scheduling of PDSCH receptions or PUSCH transmissions.

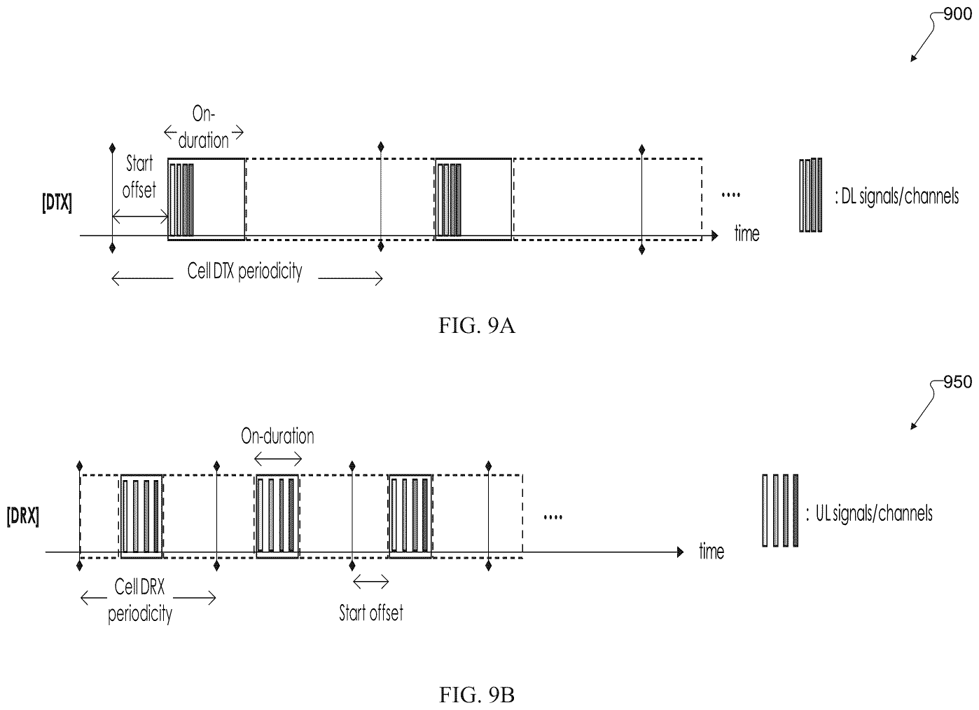

FIGS. 9A and 9B illustrate timelines for example cell DTX and DRX 900 and 950, respectively, according to embodiments of the present disclosure. For example, DTX 900 and DRX 950 can be followed by the BS 102 of FIG. 1. This example is for illustration only and other embodiments can be used without departing from the scope of the present disclosure.

In order to enable a gNB to operate a cell on sleep state and save energy while minimizing an impact on served UEs on the cell, the gNB (e.g., the gNB 102) can apply discontinued transmissions (cell DTX) or discontinued receptions (cell DRX) on the cell. A UE can be informed of corresponding cell DTX/DRX configurations for a cell such that the UE can operate accordingly and avoid power consumption when the cell is in a dormant state (cell DTX/DRX). By turning off (each) part of a transmission chain and pausing transmission during the cell DTX, the gNB can reduce energy consumption for standby when there is little to no traffic on a cell. For cell DTX, a UE may expect that transmissions from a serving gNB on the cell are suspended or the UE may expect that some signals, such as primary synchronization signal (PSS) or secondary synchronization signal (SSS) for maintaining synchronization, remain present during cell DTX. By turning off (each) part of receiver chain and pausing receptions during the cell DRX, the gNB can reduce energy consumption for standby on a cell when there is little to no traffic on the cell. For cell DRX, a UE may expect that transmissions from the UE on a cell are suspended or may expect that some transmissions, such as ones required for initial access such as PRACH, are allowed during a cell DRX duration.

With reference to FIGS. 9A and 9B, cell DTX/DRX can be configured via at least a periodicity, a start slot/offset, and an on-duration. A UE expects that transmissions/receptions by the gNB on a cell are enabled during the DTX/DRX on-duration, respectively. The configurations and operations of cell DTX and cell DRX can be linked or can be separate, for example depending on DL/UL traffic characteristics on the cell.

The energy consumption by power amplifiers (PA) for each set of antenna elements (AEs) accounts for a large portion of total energy consumption by a gNB equipped with massive MIMO antennas. For network energy savings, when the traffic load is low, the gNB can turn off a subset of PAs or reduce the PA output power levels on one or more cells. For brevity, such operation is respectively referred to as spatial domain (SD) or power domain (PD) adaptation in this disclosure. Unlike cell DTX/DRX illustrated in FIGS. 9A and 9B, one advantage of SD/PD adaptation is that the network can maintain continuity of transmissions and receptions on a cell without interruptions by operating at a reduced capability.

A gNB can enable/disable AEs associated to a logical antenna port or enable/disable a subset of AEs associated to a logical antenna port for transmissions on a cell. For brevity, those adaptations of AEs are respectively referred to as Type 1 and Type 2 SD adaptations in this disclosure. The gNB may perform Type 1 SD adaptation, or Type 2 SD adaptation, or both.

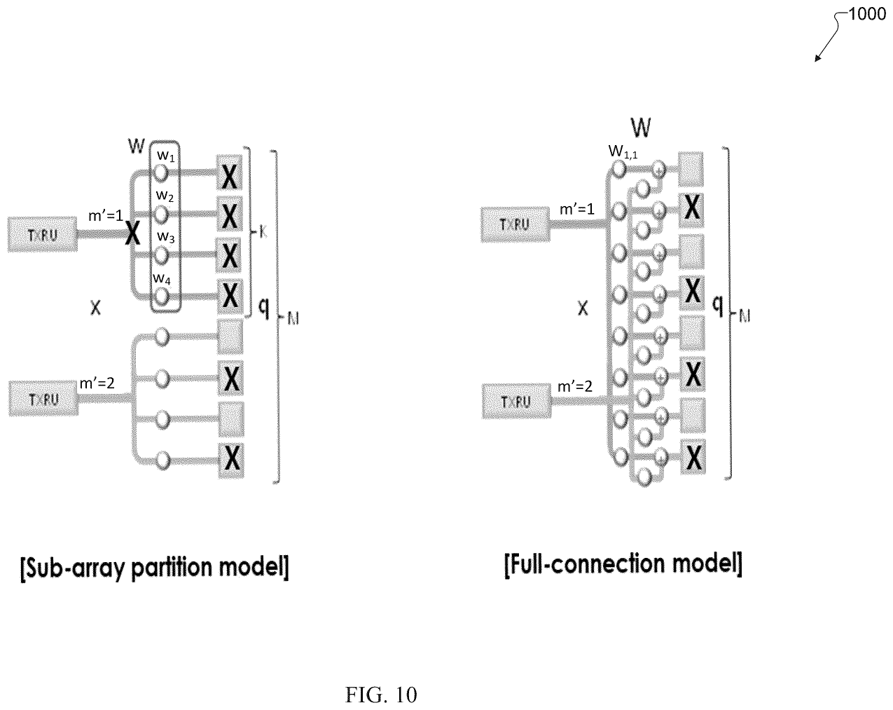

FIG. 10 illustrates diagrams of example spatial domain adaptations 1000 according to embodiments of the present disclosure. For example, spatial domain adaptations 1000 can be implemented by the BS 103 of FIG. 1. This example is for illustration only and other embodiments can be used without departing from the scope of the present disclosure.

In a hybrid beamforming system as illustrated in FIG. 5, one antenna port is connected to a large number of AEs that can be controlled by a bank of analog phase shifters, which is referred to as TxRU virtualization. The TxRU virtualization can be implemented based on sub-array partition model, full-connection model, or combinations of them, as illustrated in FIG. 10. In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless the antenna ports are turned off.

The impact of Type 1 SD adaptation results in a change in a number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations on a cell, together with other time/frequency domain adaptation techniques such as cell DTX/DRX.

Network operation parameters for transmission or reception on a cell can be in one or more of a power, spatial, time, or frequency domain.

For example, in power domain, a first NW operation state for a cell can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states for a cell can be respectively associated with first and second values of parameter powerControlOffsetSS that provides a power offset (in dB) of non-zero power (NZP) CSI-RS RE to SSS RE. For example, first and second NW operation states for a cell can be respectively associated with first and second values of parameter powerControlOffset that provides a power offset (in dB) of PDSCH RE to NZP CSI-RS RE.

For example, in frequency domain, first and second NW operation states for a cell can be respectively associated with first and second values of a parameter locationAndBandwidth that indicates a frequency domain location and a bandwidth for receptions or transmissions by a UE on the cell. For example, first and second NW operation states for a cell can be respectively associated with first and second values of a parameter BWP-Id for an active DL BWP or an active UL on the cell. For example, first and second NW operation states can be respectively associated with first and second values of a list of cells for active transmission and reception. The cells can be serving cells or non-serving cells for example in case of mobility.

For example, in spatial domain, first and second NW operation states for a cell can be respectively associated with first and second values of a parameter maxMIMO-Layers that indicates a maximum number of MIMO layers to be used for PDSCH receptions by a UE in the associated active DL BWP of the cell, or with first and second values of a parameter nrOfAntennaPorts that indicates a number of antenna ports to be used for codebook determination for PDSCH receptions on the cell, or with first and second values of a parameter activeCoresetPoolIndex for coresetPoolIndex values for PDCCH reception in corresponding CORESETs on the cell and the UE can skip PDCCH receptions in a CORESET with a coresetPoolIndex value that is not indicated by activeCoresetPoolIndex. For example, first and second NW operation states for a cell can be respectively associated with first and second values of an antenna port subset that indicates a list of active antenna ports for CSI calculation and other associated parameters such as codebook subset restriction, rank restriction, the logical antenna size in two-dimension, number of antenna ports, and a list of CSI-RS resources, etc., for the cell.

For example, in time domain, first and second NW operation states for a cell can be respectively associated with first and second values of a parameter ssb-PeriodicityServingCell that indicates a transmission periodicity in milliseconds for SS/PBCH blocks on the cell, or with first and second values of a parameter ssb-PositionsInBurst that indicates time domain positions of SS/PBCH blocks in a SS/PBCH block transmission burst on the cell, or with first and second values of a parameter groupPresence that indicates groups of SS/PBCH blocks, such as groups of four SS/PBCH blocks with consecutive indexes, that are transmitted on the cell. For example, first and second NW operation states for a cell can be respectively associated with first and second values of a time pattern, e.g., in terms of periodicity, on-duration, start offset, etc., that indicates Cell DTX or Cell DRX for the cell.

For brevity, a DCI format that provides indication of an operation state on a cell is referred to as DCI format 2_9 in this embodiment of the disclosure.

A serving gNB may adapt an operation state on a cell from one state to another, such as activation/deactivation of Cell DTX/DRX, for network energy savings while supporting the current traffic demand which can be indicated to a UE via a PDCCH providing DCI format 2_9. Therefore, embodiments of the present disclosure define procedures and methods for a UE to monitor PDCCH for detection of DCI format 2_9, including configuration of one or more search space sets for monitoring PDCCH providing DCI format 2_9, retrieving and processing information from the received DCI format 2_9, and determining subsequent communication parameters and procedures according to the indicated network operation state in DCI format 2_9 for transmissions or receptions.

Further, depending on a current operation state on a cell, transmission or reception parameters on the cell can be different, such as Cell DTX/DRX. Therefore, there is another need to define procedures and methods for a UE to monitor PDCCH candidates for detection of DCI format 2_9 depending on the current operation state on a cell, such as on-duration of Cell DTX/DRX, off-duration of Cell DTX/DRX, or Cell DTX/DRX being deactivated.

A gNB may decide to update an operation state on a cell, such as Cell DTX/DRX activation/deactivation, while a UE is in RRC_INACTIVE or RRC_IDLE state. In order for the UE to correctly assume the updated operation state on the cell when the UE transitions into the RRC_CONNECTED state, there is a need for defining procedures and methods for the UE to monitor PDCCH for detection of DCI format 2_9 while the UE is in the RRC_INACTIVE or RRC_IDLE state.

Embodiments of the present disclosure define functionalities and procedures for adapting operation states on a cell in one or more of a power, spatial, time, or frequency domain, for example in order to support network energy savings for the cell.

Embodiments of the present disclosure further define procedures and methods for a UE to monitor PDCCH providing DCI format 2_9 indicating a current operation state on a cell.

Embodiments of the present disclosure also define fields of DCI format 2_9 supporting functionalities and procedures for adaptation of an operation state on a cell.

Embodiments of the present disclosure further define a UE behavior for PDCCH monitoring to receive DCI format 2_9 depending on a current operation state on a cell.

Embodiments of the present disclosure additionally define procedures and methods for a UE to monitor PDCCH providing DCI format 2_9 when the UE is in the RRC_INACTIVE or RRC_IDLE state.

Embodiments of the present disclosure for adapting operation state on a cell in one or more of a power, spatial, time, or frequency domain, for example in order to support network energy savings for the cell, are summarized in the following and are fully elaborated further herein.
Method and apparatus for monitoring PDCCH providing DCI format 2_9 indicating a current operation state on a cell.
Method and apparatus for defining and processing fields of DCI format 2_9 supporting functionalities and procedures for adaptation of an operation state on a cell.
Method and apparatus for defining a UE behavior for PDCCH monitoring to receive DCI format 2_9 depending on a current operation state on a cell.
Method and apparatus for defining procedures and methods for a UE to monitor PDCCH providing DCI format 2_9 when the UE is in the RRC_INACTIVE or RRC_IDLE state.

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Embodiments of the present disclosure provide for an adaptation of operation states on a cell. The general principle for adapting operation states on a cell includes a serving gNB indicating to a UE a set of operation states on the cell by higher layer signaling, such as by a SIB or UE-specific RRC signaling, and transmitting a PDCCH that provides a DCI format (DCI format 2_9) indicating one or more indexes from the set of operation states on the cell for the UE to determine an update of operation states.

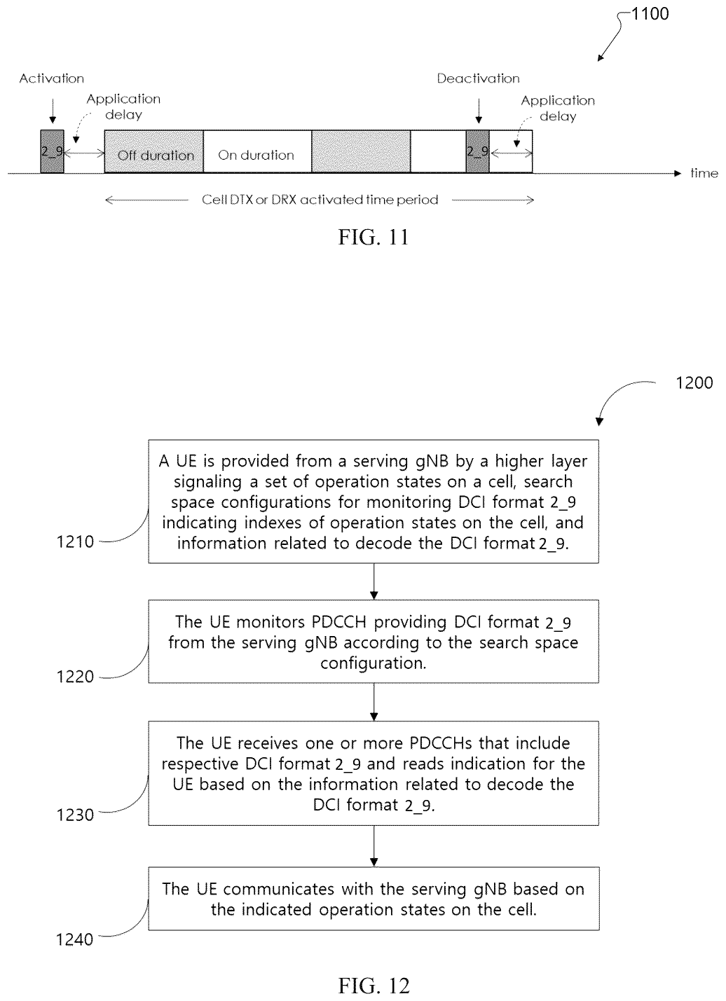

FIG. 11 illustrates an example cell DTX/DRX activation/deactivation 1100 on a cell using DCI format 2_9 according to embodiments of the present disclosure. For example, cell DTX/DRX activation/deactivation 1100 can be implemented by the BS 102 of FIG. 1. This example is for illustration only and other embodiments can be used without departing from the scope of the present disclosure.

A Cell DTX or a Cell DRX is an example of an operation state on a cell having discontinued transmission or reception on the cell during off-duration, respectively. For example, the UE may not monitor PDCCH providing dynamic grants for PDSCH receptions or may not receive semi-persistent scheduled (SPS) PDSCH during Cell DTX off-duration. During Cell DRX off-duration, the UE may not transmit configured grant (CG) PUSCH or a PUCCH with a scheduling request (SR) or a CSI report. Some operation states can be defined such that Cell DTX or Cell DRX is not used, and the UE assumes continuous transmission or reception on the cell, i.e., normal operation.

FIG. 11 illustrates activation of a Cell DTX or Cell DRX upon receiving PDCCH providing DCI format 2_9 indicating activation after an application delay and deactivation of a Cell DTX or Cell DRX upon receiving PDCCH providing DCI format 2_9 indicating deactivation after an application delay. The application delay from the reception of PDCCH providing DCI format 2_9 until the activation or deactivation of an operation state on a cell can be predefined or provided to the UE via higher layer signaling.

The Cell DTX or Cell DRX pattern may be with respect to an absolute timing, e.g., system frame number (SFN). Denote by O_{DTX}, K_{DTX}, and D_{DTX}, the start offset, periodicity, and on-duration of a given Cell DTX configuration, respectively. For a given SCS configuration numerology μ, the Cell DTX on-duration starts from subframe n_{s,f} in frame n_{f} satisfying (n_{f}·Nₛₗₒₜ^{frame, μ}+n_{s,f}^{μ}−O_{DTX})mod K_{DTX}=0 for D_{DTX} time duration, and off-duration follows slot for K_{DTX}-D_{DTX} time duration and, then, the pattern repeats. The Cell DRX pattern can be similarly described. In this case, when the Cell DTX or Cell DRX is activated, such as application delay after receiving PDCCH providing DCI format 2_9, the pattern may start with on-duration or off-duration depending on the first active slot index according to the modular equation above.

Alternatively, the Cell DTX or Cell DRX pattern may be relative to the timing of PDCCH reception providing DCI format 2_9 with or without an application delay, denoted by applicationDelay. The application delay can be a time required by a UE and by the cell to switch between operation states and, particularly, from an off-state to an on-state for Cell DTX or Cell DRX. The Cell DTX or Cell DRX may be specified to start with on-duration, off-duration, or the UE may be indicated by higher layer signaling whether the Cell DTX or Cell DRX starts with on-duration or off-duration. If the Cell DTX starts with an on-duration and if the UE is configured with a start offset O_{DTX}, the first on-duration begins applicationDelay+O_{DTX} after the reception of PDCCH providing DCI format 2_9 for D_{DTX} time duration followed by off-duration for K_{DTX}-D_{DTX} time duration and, the pattern repeats until deactivated. If the Cell DTX starts with an off-duration and if the UE is configured with a start offset O_{DTX}, the first off-duration begins applicationDelay+O_{DTX} after the reception of PDCCH providing DCI format 2_9 for K_{DTX}-D_{DTX} time duration followed by on duration for D_{DTX} time duration and, the pattern repeats until deactivated. It is also possible that one or more of K_{DTX}, D_{DTX}, and O_{DTX} are indicated by DCI format 2_9.

A reception of a PDCCH providing DCI 2_9 can be over a time window at predetermined instances and the UE may monitor PDCCH for detection of DCI format 2_9 over more than one occasions in time within the time window in order to improve reception reliability of DCI format 2_9. The UE can also be configured to receive repetitions of PDCCH providing format 2_9. For example, for PDCCH monitoring occasions at same or different time instances, the UE can be configured to combine soft metrics from receptions of PDCCH candidates. For example, the PDCCH candidates can have a same CCE aggregation level or different CCE aggregation levels. For example, the PDCCH candidates can correspond to different search space sets and have a same index and a same CCE aggregation level wherein the search space sets can include a same number of PDCCH candidates per CCE aggregation level. For example, for a time window that includes four PDCCH monitoring occasions (MOs) in time, the UE can combine a PDCCH candidate with a given index and a given CCE aggregation level for predetermined or indicated PDCCH MOs, such as the first and second MOs, the third and fourth MOs, or the first, second, third, and fourth MOs.

In the above examples, the start offset O_{DTX} time period until the first on-duration or off-duration can be regarded as Cell DTX on-duration or off-duration and can be predefined. Alternatively, the UE may be indicated by higher layer signaling whether the start offset time duration shall be assumed as on-duration or off-duration. The Cell DRX can be similarly described.

The O_{DTX}, K_{DTX}, and D_{DTX} for Cell DTX, O_{DRX}, K_{DRX}, and D_{DRX} for Cell DRX and, applicationDelay can be indicated to the UE by higher layer signaling in ms, slots, subframes, or in symbols.

An operation state on a cell is a general concept that includes Cell DTX or Cell DRX as an example, wherein a state can be defined by transmission or reception parameters in one or more of a power, spatial, time, or frequency domain on the cell, where the parameters may be indicated and applied per-TRP or commonly across multiple TRPs of the cell. For example, a Cell DTX or a Cell DRX can be considered an operation state in time where transmission from or receptions by, respectively, a cell can occur.

In one example, a set of operation states on a cell provided to a UE by higher layer signaling may be associated with one or more Cell DTX or Cell DRX patterns defined by parameters such as periodicity, start slot/offset, on-duration, and associated timer values, e.g., fallback timers to switch to a default state. For example, if the UE does not receive PDCCH providing a DCI format 2_9 for the associated timer duration, the UE falls back to a default operation state for a cell or a set of cells. The default operation state per cell or per set of cells can be predefined in the specifications of the system operation or indicated to the UE via higher layer signaling. As a default operation state for a cell, for instance, the Cell DTX/DRX is assumed to be deactivated and the UE is required to monitor PDCCH for detection of DCI formats scheduling PDSCH receptions or PUSCH transmissions, or to receive semi-persistent scheduled (SPS) PDSCH, or to transmit configured grant (CG) PUSCH or PUCCH with UCI such as a scheduling request (SR).

In another example, a set of operation states on a cell may be associated with different SRS transmission configurations, such as transmissionComb, resourceMapping (incl., startPosition, nrofSymbols, repetitionFactor), freqDomainPosition, freqDomainShift, freqHopping, periodicityAndOffset (which is applicable for semi-persistent and periodic SRS, not including an aperiodic SRS), and spatialRelationInfo.

In yet another example, a set of operation states on a cell may be associated with different PDCCH monitoring configurations, such as search space sets, monitoring periodicity, offset, or duration, etc. For instance, different monitoring configurations can be associated with operation states on a cell for receiving SIBs (Type 0/0A CSS), or paging, or message (MSG) 2/3/4 during random access (Type 1 CSS), paging (Type 2 CSS), other UE group common signaling for functionalities without scheduling transmissions/receptions from one UE (Type 3 CSS), or UE-specific scheduling of transmissions/receptions (USS), not including configuration for receiving DCI format 2_9. For another instance, different sets of coresetPoolIndexes can be associated with operation states on a cell for monitoring PDCCH.

An operation state may also correspond to a hypothesis on transmission parameters on the cell for a UE to provide CSI reports. For example, a UE can be provided with one or multiple powerControlOffset values, one or multiple powerControlOffsetSS values, or one or multiple ss-PBCH-BlockPower values, which correspond to different power domain hypotheses for CSI reporting. In another example, a UE can be provided with one or multiple antenna port subset indications, e.g., using bitmap, one or multiple codebook configurations, one or multiple lists of CSI-RS resource indexes, or one or multiple other CSI report configurations such as CQI table, report quantity, and reportFreqConfiguration, which correspond to different spatial domain hypotheses for CSI reporting. The one or multiple codebook configuration includes one or more of antenna configuration, e.g., horizontal and vertical dimensions of the antenna panel, number of antenna panels, number of TRPs, codebook subset restriction, and rank restriction. In another example, a UE can be provided with one or multiple frequency range configurations, e.g., locationAndBandwidth or DL/UL BWP ID, which correspond to different frequency domain hypotheses for CSI reporting.

Embodiments of the present disclosure provide for receiving DCI format 2_9 in RRC CONNECTED state. A DCI format 2_9 indicating one or more indexes from the set of operation states on the cell can be UE-specific (such as with CRC scrambled by C-RNTI, or associated with a PDCCH reception in CCEs determined according to a USS), UE-group-specific (such as with CRC scrambled by a UE-group-specific RNTI provided by UE-specific higher layer signaling, e.g., NES-RNTI, or associated with a PDCCH reception in CCEs determined according to a CSS based on CSS sets indicated by UE-specific higher layer signaling), or cell-specific for PDCCH receptions based on CSS sets indicated by system information.

FIG. 12 illustrates an example flowchart of a method 1200 for adapting operation states on a cell using DCI format 2_9 according to embodiments of the present disclosure. For example, the method 1200 can be implemented by the UE 116 of FIG. 3 and a complementary method may be performed by a BS, such as BS 102 of FIG. 2. This example is for illustration only and other embodiments can be used without departing from the scope of the present disclosure.

A UE is provided from a serving gNB by higher layer signaling a set of operation states on a cell, at least one search space set configuration for monitoring PDCCH for detection of a DCI format 2_9 indicating indexes of operation states on the cell, and information related to decoding the DCI format 2_9 such as a size of DCI format 2_9 (1210). The higher layer signaling can be an RRC IE. The set of operation states, the search space sets configuration, and the information related to decode the DCI format 2_9 may also be updated by a MAC CE that indicates corresponding subsets of the ones provided in the RRC IE.

The set of operation states on a cell can be provided per BWP for the cell, or be common to all BWPs of the cell, or per group of cells wherein one group of cells includes the cell. There may be a maximum number of operation states for a cell that can be provided to a UE by a higher layer signaling, which can be denoted as Nₘₐₓ. For Cell DTX or Cell DRX as an example operation state on a cell, the UE may be provided with up to Nₘₐₓ^{DTX} Cell DTX and Nₘₐₓ^{DRX} Cell DRX configurations, wherein Nₘₐₓ^{DTX} and Nₘₐₓ^{DRX} may be identical. The Cell DTX and Cell DRX can be jointly configured as an operation state of a cell. For instance, up to Nₘₐₓ Cell DTX and DRX pairs can be provided to the UE for a cell, which can be indicated using a pair of indexes from a set of Cell DTX configurations and a set of Cell DRX configurations. If, in addition to a normal UL (NUL) carrier paired with a DL carrier, a cell includes a supplemental uplink (SUL) carrier, a set of operation states, e.g., a set of Cell DRX configurations, can be separately provided to the UE for transmission on the NUL carrier and the SUL carrier. Alternatively, a set of operation states can be common for transmissions on the NUL carrier and the SUL carrier, e.g., a set of Cell DRX configurations apply to both NUL and SUL. Alternative approaches of operating SUL may be configurable to the UE via higher layer signaling.

A Cell DTX or Cell DRX, or more generally an operation state on a cell, may be activated once configured by RRC and deactivated when the RRC configuration is released. The RRC signaling may provide a default Cell DTX/DRX configuration, or more generally an operation state on a cell, which becomes activated when RRC configured. Alternatively, the default Cell DTX/DRX, or an operation state, may be implicitly assumed by the UE, e.g., the first Cell DTX/DRX or operation state configuration, which can be predefined in the specifications of the system operation. If the UE is provided only one Cell DTX/DRX or operation state on a cell, the UE assumes that the provided configuration becomes activated when RRC configured. During the RRC configuration, there may be an ambiguity time period between the UE and the gNB on the exact time instance when the RRC configuration becomes effective. Therefore, during such a time period, a UE may assume the current mode of operation on the cell, i.e., Cell DTX/DRX being inactive, or the current/default Cell DTX/DRX or operation state on the cell such as one with default parameters that can be a subset of parameters for every other operation state associated with activated transmissions/receptions on the cell. Such a time period for UE to assume the current mode of operation may be predefined in the specifications of the system operation or indicated to the UE as a part of RRC signaling.

If a UE monitors PDCCH for detection of DCI format 2_9 according to CSS sets, the DCI format 2_9 includes one or more blocks of information such as {block 1, block 2, . . . , block X}, where the starting position of a block for the UE is indicated by higher layer signaling for the UE, when there are more than one blocks. If there is only a single block of information in the DCI format 2_9, the information is common to all the intended UEs and no indication on the starting position of a block is provided to the UEs. After correct decoding of DCI format 2_9, the UE retrieves one or more indexes, as applicable, from the set of operation states on the cell from a corresponding block in the received DCI format 2_9. The blocks of information can include same or different number of bits. A same or a different block can include indication of operation states for more than one cells configured for communication to the UE. For example, a block of M bits can indicate operation states for a set of N cells, and cells configured to the UE can be included in the set of N cells or can be included in different sets of N cells addressed by different blocks of bits.

The UE monitors PDCCH providing DCI format 2_9 from the serving gNB according to respective configurations of search space sets (1220). The UE behavior for monitoring PDCCH providing DCI format 2_9 can be different during the Cell DTX/DRX deactivated time period, during on-duration of the Cell DTX/DRX, and during off-duration of the Cell DTX/DRX. The UE can be configured different search space sets for monitoring PDCCH for detection of DCI format 2_9 during on-duration of the Cell DTX/DRX (first search space sets) and during off-duration of the Cell DTX/DRX (second search space sets). In case the UE is configured for operation with multiple cells, the UE can monitor PDCCH for detection of DCI format 2_9 according to one of the first or second search space sets such as, for example, the second search space sets when all cells are in off-duration of the Cell DTX/DRX; otherwise, the first search space sets.

The UE then receives one or more PDCCHs that include respective DCI format 2_9 and reads an indication for the UE based on the information related to decode the DCI format 2_9 (1230). The UE then communicates with the serving gNB based on the indicated operation states on the cell (1240).

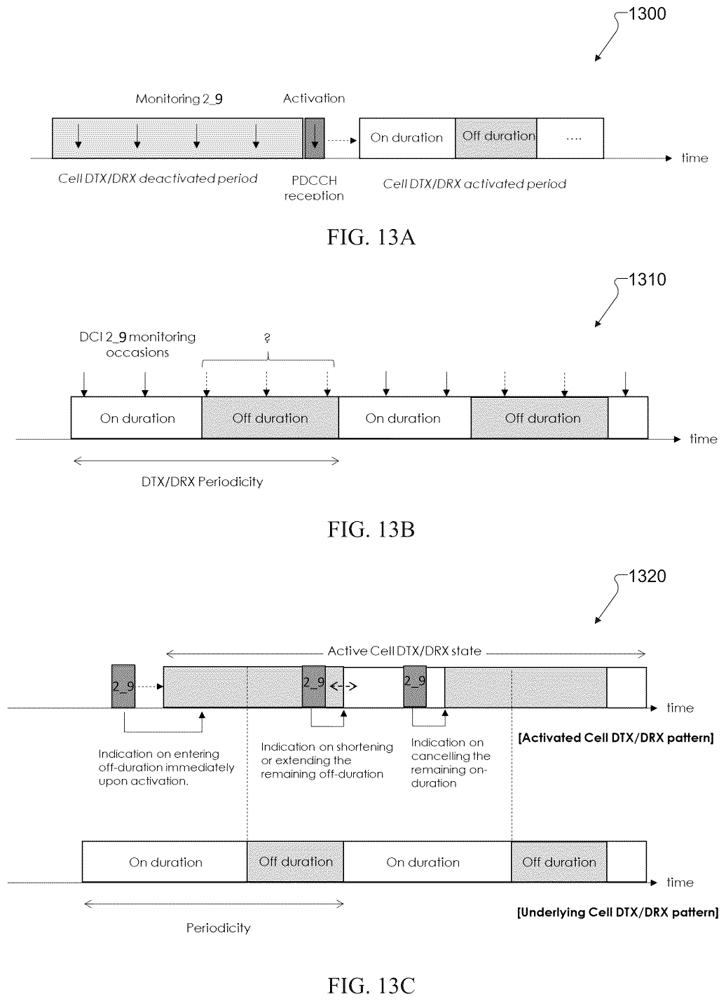

FIG. 13A illustrates an example UE PDCCH monitoring behavior 1300 for receiving DCI format 2_9 during Cell DTX/DRX deactivated period as an example operation state on a cell according to embodiments of the present disclosure. For example, the UE PDCCH monitoring behavior 1300 can be implemented by the UE 116 of FIG. 1. This example is for illustration only and other embodiments can be used without departing from the scope of the present disclosure.

When Cell DTX or Cell DRX is deactivated, a UE may assume continuous transmission or reception on the cell. Therefore, the UE monitors PDCCH providing DCI format 2_9 from the serving gNB periodically according to the search space configuration during the Cell DTX or Cell DRX deactivated time period.

FIG. 13B illustrates an example DCI format 2_9 monitoring occasions 1310 when Cell DTX/DRX is activated on a cell according to embodiments of the present disclosure. For example, the DCI format 2_9 monitoring occasions 1310 can be utilized by the UE 116 of FIG. 1. This example is for illustration only and other embodiments can be used without departing from the scope of the present disclosure.

UE is provided from the serving gNB a search space configuration for monitoring DCI format 2_9 including controlResourceSetId, monitoringSlotPeriodicityAndOffset, duration, monitoringSymbolsWithinSlot, nrofCandidates, and searchSpaceType.

In one example, the UE is provided a search space configuration, which applies to both Cell DTX/DRX on-durations and off-durations for the UE to monitor a PDCCH providing DCI format 2_9. The UE may follow the same search space configuration, or the UE is provided separate search space configurations for monitoring DCI format 2_9 for the time duration when Cell DTX/DRX is deactivated and for the time duration when Cell DTX/DRX is activated.

In another example, the UE is provided separate search space configurations for the Cell DTX/DRX on-durations and for the Cell DTX/DRX off-durations for monitoring a PDCCH providing DCI format 2_9. The entirety of SearchSpace information elements can be separately provided for the Cell DTX/DRX on-durations and for the Cell DTX/DRX off-durations. Alternatively, only a subset of parameters, such as monitoringSlotPeriodicityAndOffset, can be separately provided for monitoring a PDCCH providing DCI format 2_9 during Cell DTX/DRX off-durations.

In yet another example, the UE is provided a search space configuration, which applies to both Cell DTX/DRX on-durations and off-durations for the UE to monitor a PDCCH providing DCI format 2_9, while the UE only monitors at every N-th monitoring occasion during Cell DTX/DRX off-durations. In one example, the UE only monitors at even or odd monitoring occasions during Cell DTX/DRX off-durations. In another example, the UE only monitors at monitoring occasions, i.e., a subframe with number n_{s,f}^{μ} in a frame with number n_{f}, satisfying (n_{f}·Nₛₗₒₜ^{frame,μ}+n_{s,f}^{μ}−oₛ)mod N·kₛ=0, where the parameter N is additionally provided to the UE for monitoring a PDCCH providing DCI format 2_9 during Cell DTX/DRX off-durations.

The serving gNB may not always transmit a PDCCH providing DCI format 2_9 at every DCI 2_9 monitoring occasions. For example, during Cell DTX/DRX off-durations, the serving gNB may skip transmitting a PDCCH providing DCI format 2_9 for network energy saving, unless the serving gNB wants to switch the operation state on the cell. For another example, a UE may fail to detect a PDCCH providing DCI format 2_9, while it was transmitted by the serving gNB.

If a UE does not detect a PDCCH providing DCI format 2_9 at a monitoring occasion for DCI format 2_9, the UE shall assume that the current operation state on the cell is maintained. For instance, if the UE does not detect a PDCCH providing DCI format 2_9 at its monitoring occasion while the Cell DTX (or Cell DRX) is activated (or deactivated), the UE shall assume active Cell DTX (or Cell DRX) state (or inactive Cell DTX state) on the cell.

FIG. 13C illustrates an example of an underlying Cell DTX/DRX pattern and an activated pattern with DCI format 2_9 1320 according to embodiments of the present disclosure. For example, the underlying Cell DTX/DRX pattern and an activated pattern with DCI format 2_9 1320 can be utilized by the UE 116 of FIG. 1. This example is for illustration only and other embodiments can be used without departing from the scope of the present disclosure.

The Cell DTX or Cell DRX pattern may be with respect to an absolute timing, e.g., SFN. In this case, when DCI format 2_9 is received for the activation of Cell DTX/DRX, the activation time may correspond to Cell DTX/DRX on-duration or off-duration depending on the underlying Cell DTX/DRX pattern as illustrated in FIG. 13C. When the Cell DTX/DRX is activated, the serving gNB may want to enter off-duration immediately for network energy saving. Thus, in one example, the DCI format 2_9 may provide an indication to the UE to enter off-duration, e.g., using 1-bit binary indication each for Cell DTX and for Cell DRX or jointly, regardless of the underlying Cell DTX/DRX pattern, along with an indication on the activation of Cell DTX/DRX. Alternatively, it is predefined in the specifications of the system operation such that a UE assumes off-duration by default when the UE receives DCI format 2_9 indicating an activation of Cell DTX/DRX, regardless of the underlying Cell DTX/DRX pattern.

In another example, the DCI format 2_9 may indicate shortening, extending, or entirely canceling the remaining on-duration or off-duration, during which the DCI format 2_9 is received, as illustrated in FIG. 13C. When the current on-duration or off-duration is shortened or extended, the shortened/extended duration can be indicated by the DCI format 2_9, where the duration can be in a number of symbols, slots, or ms. The indication can be via an index to the set of duration values predefined in the specifications of the system operation or provided by a higher layer signaling.

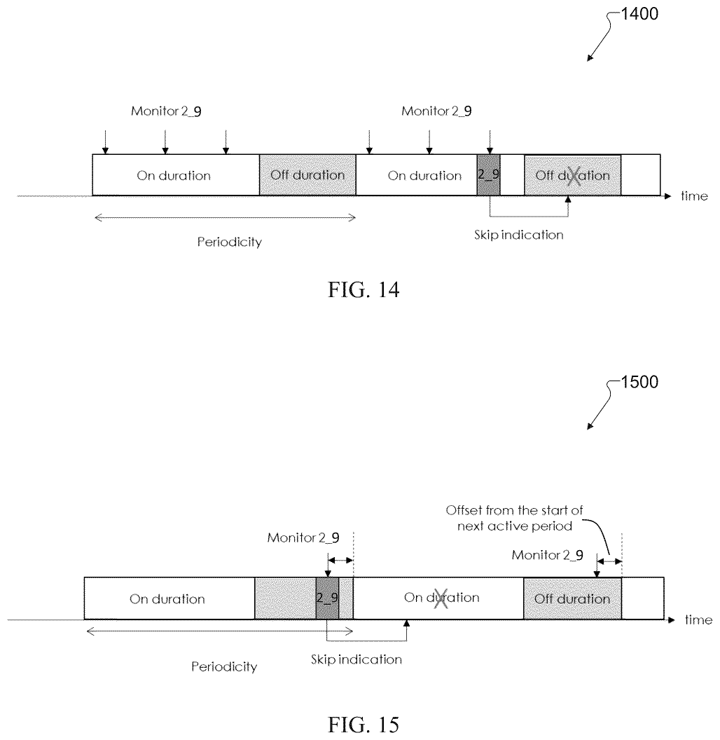

FIG. 14 illustrates an example UE PDCCH monitoring behavior 1400 for receiving DCI format 2_9 during Cell DTX/DRX on-duration on a cell according to embodiments of the present disclosure. For example, UE PDCCH monitoring behavior 1400 can be implemented by the UE 116 of FIG. 1. This example is for illustration only and other embodiments can be used without departing from the scope of the present disclosure.

In one example, a UE monitors PDCCH providing DCI format 2_9 only for monitoring occasions that are within a Cell DTX or Cell DRX on-duration, and the UE skips PDCCH monitoring during Cell DTX or Cell DRX off-duration as illustrated in FIG. 14. During the Cell DTX/DRX on-duration, the UE monitors PDCCH providing DCI format 2_9 from the serving gNB periodically according to the search space sets configurations.

DCI format 2_9 may also indicate skipping one or more next Cell DTX or Cell DRX off-duration or on-duration in addition to indicating operation state on the cell. DCI format 2_9 may also indicate skipping monitoring PDCCH providing DCI format 2_9 for the next one or more monitoring occasions. Similarly, the UE may be indicated to skip monitoring PDCCH providing DCI format 2_9 for a certain time duration, e.g., in ms or slots. Such a time duration or a number of monitoring occasions for skipping PDCCH monitoring can be indicated in DCI format 2_9. Alternatively, a time duration or a number of monitoring occasions for skipping PDCCH monitoring is provided by higher layer signaling or predefined in the specifications of the system operation, and DCI format 2_9 only provides skipping or non-skipping indication.

In another example, during Cell DTX/DRX off-durations, the UE only monitors a PDCCH providing a DCI format 2_9 during a certain time window indicated by the DCI format 2_9 or by another DCI format. The next PDCCH monitoring window can be indicated by a start offset from the end of the PDCCH reception providing a DCI format indicating the next PDCCH monitoring window and a duration of the monitoring window. The start offset and monitoring window duration can be provided in a number of slots, symbols, or ms. Alternatively, the start offset, and monitoring window duration can be provided in an integer multiple of the monitoring occasion periodicity of the DCI format 2_9.

FIG. 15 illustrates an example UE PDCCH monitoring behavior 1500 for receiving DCI format 2_9 during Cell DTX/DRX off-duration on a cell according to embodiments of the present disclosure. For example, UE PDCCH monitoring behavior 1500 can be implemented by the UE 116 of FIG. 1. This example is for illustration only and other embodiments can be used without departing from the scope of the present disclosure.

In one example, during Cell DTX or Cell DRX off-durations, a UE monitors PDCCH providing DCI format 2_9 only for certain one or multiple monitoring occasions prior to the start of the next on-duration as illustrated in FIG. 15. Such a time duration for monitoring PDCCH prior to the start of next on-duration can be provided to the UE via higher layer signaling or predefined in the specifications of the system operation. As illustrated in the figure, the UE is provided via higher layer signaling an offset from the start of the next on-duration from which the UE starts monitoring DCI format 2_9. In one example, in a given Cell DTX off-duration, a UE does not expect to detect more than one DCI format 2_9 with different values of Cell DTX/DRX activation/deactivation indication. During the off-duration, the UE skips monitoring DCI format 2_9 until the indicated offset.

In another example, during the Cell DTX/DRX off-duration, a UE monitors PDCCH providing DCI format 2_9 from the serving gNB periodically according to the search space configuration. The UE may be provided different search space configuration for Cell DTX/DRX deactivated time period, Cell DTX/DRX on-duration, and Cell DTX/DRX off-duration, such as search space sets, monitoring periodicity, offset, and duration.

Similar to FIG. 14, the DCI format 2_9 may also indicate skipping next Cell DTX/DRX on-duration, off-duration, or one or multiple monitoring occasions for receiving PDCCH providing DCI format 2_9, in addition to indicating operation state on the cell.

In one example, the UE monitors PDCCH providing DCI format 2_9 according to the search space configuration regardless of the UE RRC CONNECTED mode DRX (C-DRX) state, i.e., DCI format 2_9 can be received both in UE C-DRX on-durations and off-durations. If the UE is not configured with C-DRX or not supporting C-DRX, the UE behavior for monitoring PDCCH providing DCI format 2_9 will be the same. In another example, if the UE is configured with C-DRX, the UE monitors PDCCH providing DCI format 2_9 only for the monitoring occasions falling into C-DRX on-duration. In yet another example, among the monitoring occasions falling in a C-DRX off-duration, the UE only monitors PDCCH providing DCI format 2_9 for the one or multiple monitoring occasions prior to the start of the following C-DRX on-duration. In yet another example, during the C-DRX off-durations, the UE monitors PDCCH providing DCI format 2_9 during the monitoring occasions for DCI format 2_6 for UE wake-up signal indication. The ps-Offset and duration configured for monitoring PDCCH providing DCI format 2_6 can be assumed for monitoring PDCCH providing DCI format 2_9. Separate offset or duration can be indicated for monitoring PDCCH providing DCI format 2_9 from those indicated for DCI format 2_6 while assuming the same periodicity. In one example, a UE monitors PDCCH providing DCI format 2_9 according to the search space configuration only when the UE receives positive Wake-up indication in DCI format 2_6, such as during the following C-DRX on-duration. If the UE receives negative Wake-up indication in DCI format 2_6, the UE may skip monitoring PDCCH providing DCI format 2_9 until receiving positive Wake-up indication in DCI format 2_6.

The UE receives one or more PDCCHs that include respective DCI format 2_9 and reads indication for the UE based on the information related to decode the DCI format 2_9. The DCI format 2_9 indicating one or more indexes from the set of operation states on a cell can be UE-specific, UE-group-specific, or cell-specific. If the DCI format 2_9 is UE-group specific, a UE retrieves information for the UE from one or more information blocks transmitted in the DCI format 2_9 using the information provided by the serving gNB via higher layer signaling, such as the size of DCI format 2_9, the starting position of a block for the UE, and the block size, etc.

If a UE is provided N operation states on a cell from the serving gNB, an index of an operation state can be indicated using a field with ceil(log₂(N)) bits in the DCI format 2_9. The operation state indication can be provided for one or more cells or cell groups and, in such a case, the DCI format 2_9 provides one or more fields with ceil(log₂(N)) bits corresponding to each cell or cell group. For Cell DTX/DRX, an index of a Cell DTX pattern can be indicated using a field with ceil(log₂(Nₘₐₓ^{DTX})) bits and an index of a Cell DRX pattern can be indicated using a field with ceil(log₂(Nₘₐₓ^{DRX})) bits in the DCI format 2_9. If a cell is paired with SUL, a separate indication from the indication for the paired cell can be provided for the SUL using a field with ceil(log₂(Nₘₐₓ^{DRX})) bits in the DCI format 2_9. In another example, if a cell is paired with SUL, Cell DRX for SUL follows the indication provided for the paired cell. When Nₘₐₓ pairs of Cell DTX and Cell DRX are provided to a UE, an indication on the operation state can be provided using a field with ceil(log₂(Nₘₐₓ)) bits in the DCI format 2_9.

A gNB may decide to adapt its operation state on a cell, such as Cell DTX/DRX activation/deactivation, while a UE is in RRC_INACTIVE or RRC_IDLE state. In order for the UE to assume correct operation state on a cell when the UE transitions into the RRC_CONNECTED state, the UE may be required to monitor PDCCH providing DCI format 2_9 while the UE is in RRC_INACTIVE or RRC_IDLE state. A search space set configuration for monitoring PDCCH providing DCI format 2_9 while a UE is in RRC_INACTIVE or RRC_IDLE state can be separately provided to the UE from the search space set configuration for monitoring PDCCH providing DCI format 2_9 in RRC_CONNECTED state. The search space set configuration for monitoring PDCCH providing DCI format 2_9 while a UE is in RRC_INACTIVE or RRC_IDLE state can be provided to a UE via RRC IE in a PDSCH reception, which can be UE-specific or cell-specific for example via a SIB. The search space set for monitoring PDCCH providing DCI format 2_9 can be Type 2/2A CSS, or Type 3 CSS.

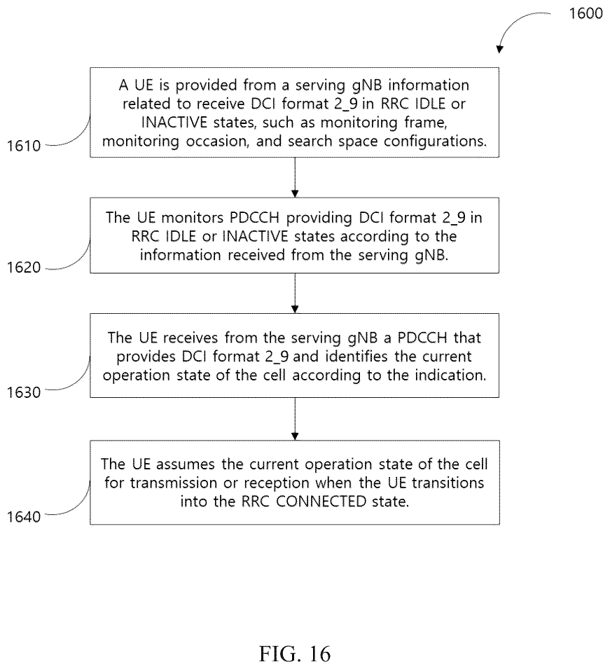

FIG. 16 illustrates an example flowchart for a method for monitoring PDCCH providing DCI format 2_9 in RRC INACTIVE/IDLE state according to embodiments of the present disclosure. For example, the method 1600 can be implemented by the UE 116 of FIG. 3 and a complementary method may be performed by a BS, such as BS 102 of FIG. 2. This example is for illustration only and other embodiments can be used without departing from the scope of the present disclosure.

A UE is provided from a serving gNB information for monitoring PDCCH to receive DCI format 2_9 in RRC IDLE or RRC_INACTIVE state, such as monitoring windows, for example in terms of frames of respective SFNs, and search space set configurations (1610). The UE monitors PDCCH providing DCI format 2_9 in RRC_INACTIVE or RRC_IDLE states according to the information received from the serving gNB (1620). The UE receives from the serving gNB a PDCCH that provides DCI format 2_9 and identifies the current operation state of the cell according to the indication (1630). The UE assumes the current operation state of the cell for transmission or reception when the UE transitions into the RRC_CONNECTED state (1640). Further detailed embodiments for method 1600 is provided in the following.

A NES monitoring occasion (NMO) is a set of PDCCH monitoring occasions over multiple time instances (e.g., slots or OFDM symbols) where DCI format 2_9 can be received. One NES monitoring Frame (NMF) may contain one or multiple NMO(s) or starting point of a NMO. The NMF and NMO for receiving DCI format 2_9 in RRC_INACTIVE/IDLE states are determined by the following formulae:
SFN for the NMF is determined by: (SFN+NMF_offset)mod T=(T div N)*(ID mod N)
Index (i_s), indicating the index of the NMO is determined by: i_s=floor (ID/N)mod Ns,
   where NMF_offset is an offset used for NMF determination, T is certain periodicity, e.g., DRX cycle of the UE, N is the number of total NMFs in T, and Ns is the number of NMOs for an NMF. The ID may be NES-RNTI of DCI 2_9. In another example, the ID is an ID of the UE, which can be, for example, a function of Temporary Mobile Subscriber Identity (TMSI), Subscription Concealed Identifier (SUCI), Subscription Permanent Identifier (SUPI), 5G Globally Unique Temporary Identity (5G-GUTI), International Mobile Subscriber Identity (IMSI), or International Mobile Equipment Identity (IMEI). If the UE has no UE-ID, for instance when the UE has not yet registered onto the network, the UE shall use as default identity UE_ID=0 in the NMF and NMO formulas above. The configuration for PDCCH monitoring occasions, including the parameters listed above, for receiving DCI format 2_9 in RRC INACTIVE/IDLE states are provided by higher layer signalling.

When SearchSpaceId=0 is configured, the PDCCH monitoring occasions for DCI format 2_9 can be the same as for RMSI as defined in clause 13 in TS 38.213 [3] in case the PDCCH transmissions are on a primary cell. When SearchSpaceId=0 is configured, Ns is either 1 or 2. For Ns=1, there is only one NMO which starts from the first PDCCH monitoring occasion for DCI format 2_9 in the NMF. For Ns=2, NMO is either in the first half frame (i_s=0) or the second half frame (i_s=1) of the NMF.

When SearchSpaceId other than 0 is configured, or for PDCCH monitoring for detection of DCI format 2_9 on a secondary cell, the UE monitors the (i_s+1)^{th} NMO. A NMO is a set of ‘S*X’ consecutive PDCCH monitoring occasions where ‘S’ is the number of actual transmitted SSBs determined according to ssb-PositionsInBurst in SIB1 and X is the number of PDCCH monitoring occasions per SSB in NMO. The [x*S+K]^{th} PDCCH monitoring occasion for receiving DCI format 2_9 in the NMO corresponds to the Kth transmitted SSB, where x=0, 1, . . . , X−1, K=1, 2, . . . , S. The PDCCH monitoring occasions for DCI format 2_9 which do not overlap with UL symbols (determined according to tdd-UL-DL-ConfigurationCommon) are sequentially numbered from zero starting from the first PDCCH monitoring occasion for DCI format 2_9 in the NMF. The UE can be provided first PDCCH monitoring occasion of NMO. Then, the starting PDCCH monitoring occasion number of (i_s+1)^{th} NMO is the (i_s+1)^{th} value of the provided first PDCCH monitoring occasion of NMO; otherwise, it is equal to i_s*S*X. If X>1, when the UE detects a PDCCH transmission addressed to NES-RNTI within its NMO, the UE is not required to monitor the subsequent PDCCH monitoring occasions for this NMO. Alternatively, the UE may be required to continue to monitor the subsequent PDCCH monitoring occasions regardless of the first reception of PDCCH providing DCI format 2_9. The corresponding UE behaviour can be predefined in the specifications of the system operation or indicated to the UE via higher layer signalling.

Part or all of the parameters list above for determining NMF and NMO may be provided to a UE via RRC IE in a PDSCH reception, which can be UE-specific or cell-specific for example via a SIB. In another example, a search space set configuration for monitoring PDCCH providing DCI format 2_9 while a UE is in RRC_INACTIVE or RRC_IDLE state can be assumed to be identical to a Type2-PDCCH CSS set configured by pagingSearchSpace in PDCCH-ConfigCommon or a Type2A-PDCCH CSS set configured by peiSearchSpace in DownlinkConfigCommonSIB.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method performed by a user equipment (UE), the method comprising:
receiving:
first information related to one or more sets of parameters associated with respective one or more cell discontinuous transmission (DTX) or cell discontinuous reception (DRX) configurations on a cell, wherein the one or more sets of parameters include:
a periodicity,
a start offset, and
an on-duration timer;
second information related to a reception of an indication for activation or deactivation of the cell DTX or the cell DRX from the one or more cell DTX or cell DRX configurations; and
the indication based on the second information;
determining one of:
an active period and an inactive period of the cell DTX based on the indication and the first information; or
an active period and an inactive period of the cell DRX based on the indication and the first information; and
one of:
receiving channels or signals on the cell based on the determined active and inactive periods of the cell DTX; or
transmitting channels or signals on the cell based on the determined active and inactive periods of the cell DRX.

2. The method of claim 1, wherein determining the active period of the cell DTX or the cell DRX further comprises determining a starting subframe of a cycle for the cell DTX or the cell DRX satisfying:
$$( {n}_{f} \cdot N + {n}_{s , f} - O ) mod K = 0 ,$$
where:
n_{f} is a system frame number,
N is a number of subframes in a frame,
n_{s,f} is a subframe number,
O is the start offset, and
K is the periodicity.

3. The method of claim 1, wherein:
the indication is provided by a downlink control information (DCI) format in a physical downlink control channel (PDCCH),
the PDCCH is monitored during an UE DRX active time, and
the PDCCH is not monitored during an UE DRX inactive time.

4. The method of claim 1, wherein:
the indication is provided by a downlink control information (DCI) format in a physical downlink control channel (PDCCH), and
the DCI format further indicates to skip monitoring the PDCCH for one or more subsequent monitoring occasions.

5. The method of claim 1, wherein:
the indication is provided by a downlink control information (DCI) format in a physical downlink control channel (PDCCH), and
the second information provides separate search space configuration for receiving the PDCCH during the active period and the inactive period of the cell DTX.

6. The method of claim 1, wherein the one or more cell DTX configurations are associated with respective search space configurations for receiving a physical downlink control channel (PDCCH) for a reception of at least one of:
system information,
paging,
messages during random access, and
data.

7. The method of claim 1, wherein:
the indication is provided by a downlink control information (DCI) format in a physical downlink control channel (PDCCH),
the PDCCH is received in RRC_CONNECTED, RRC_INACTIVE, and RRC_IDLE states,
PDCCH monitoring occasions during RRC_INACTIVE or RRC_IDLE state are identical to paging occasions.

8. A user equipment (UE) comprising:
a transceiver configured to receive:
first information related to one or more sets of parameters associated with respective one or more cell discontinuous transmission (DTX) or cell discontinuous reception (DRX) configurations on a cell, wherein the one or more sets of parameters include:
a periodicity,
a start offset, and
an on-duration timer;
second information related to a reception of an indication for activation or deactivation of the cell DTX or the cell DRX from the one or more cell DTX or cell DRX configurations; and
the indication based on the second information; and
a processor operably coupled to the transceiver, the processor configured to determine one of:
an active period and an inactive period of the cell DTX based on the indication and the first information; or
an active period and an inactive period of the cell DRX based on the indication and the first information,
wherein the transceiver is further configured to one of:
receive channels or signals on the cell based on the determined active and inactive periods of the cell DTX; or
transmit channels or signals on the cell based on the determined active and inactive periods of the cell DRX.

9. The UE of claim 8, wherein the processor is further configured to determine a starting subframe of a cycle for the cell DTX or the cell DRX satisfying:
$$( {n}_{f} \cdot N + {n}_{s , f} - O ) mod K = 0 ,$$
where:
n_{f} is a system frame number,
N is a number of subframes in a frame,
n_{s,f} is a subframe number,
O is the start offset, and
K is the periodicity.

10. The UE of claim 8, wherein:
the indication is provided by a downlink control information (DCI) format in a physical downlink control channel (PDCCH),
the PDCCH is monitored during an UE DRX active time, and
the PDCCH is not monitored during an UE DRX inactive time.

11. The UE of claim 8, wherein:
the indication is provided by a downlink control information (DCI) format in a physical downlink control channel (PDCCH), and
the DCI format further indicates to skip monitoring the PDCCH for one or more subsequent monitoring occasions.

12. The UE of claim 8, wherein:
the indication is provided by a downlink control information (DCI) format in a physical downlink control channel (PDCCH), and
the second information provides separate search space configuration for receiving the PDCCH during the active period and the inactive period of the cell DTX.

13. The UE of claim 8, wherein the one or more cell DTX configurations are associated with respective search space configurations for receiving a physical downlink control channel (PDCCH) for a reception of at least one of:
system information,
paging,
messages during random access, and
data.

14. The UE of claim 8, wherein:
the indication is provided by a downlink control information (DCI) format in a physical downlink control channel (PDCCH),
the PDCCH is received in RRC_CONNECTED, RRC_INACTIVE, and RRC_IDLE states,
PDCCH monitoring occasions during RRC_INACTIVE or RRC_IDLE state are identical to paging occasions.

15. A base station (BS) comprising:
a transceiver configured to transmit:
first information related to one or more sets of parameters associated with respective one or more cell discontinuous transmission (DTX) or cell discontinuous reception (DRX) configurations on a cell, wherein the one or more sets of parameters include:
a periodicity,
a start offset, and
an on-duration timer;
second information related to a transmission of an indication for activation or deactivation of the cell DTX or the cell DRX from the one or more cell DTX or cell DRX configurations; and
the indication based on the second information; and
a processor operably coupled to the transceiver, the processor configured to determine one of:
an active period and an inactive period of the cell DTX based on the indication and the first information; or
an active period and an inactive period of the cell DRX based on the indication and the first information,
wherein the transceiver is further configured to one of:
transmit channels or signals on the cell based on the determined active and inactive periods of the cell DTX; or
receive channels or signals on the cell based on the determined active and inactive periods of the cell DRX.

16. The BS of claim 15, wherein the processor is further configured to determine a starting subframe of a cycle for the cell DTX or the cell DRX satisfying:
$$( {n}_{f} \cdot N + {n}_{s , f} - O ) mod K = 0 ,$$
where:
n_{f} is a system frame number,
N is a number of subframes in a frame,
n_{s,f} is a subframe number,
O is the start offset, and
K is the periodicity.

17. The BS of claim 15, wherein:
the indication is provided by a downlink control information (DCI) format in a physical downlink control channel (PDCCH),
the PDCCH is monitored during an UE DRX active time, and
the PDCCH is not monitored during an UE DRX inactive time.

18. The BS of claim 15, wherein:
the indication is provided by a downlink control information (DCI) format in a physical downlink control channel (PDCCH), and
the DCI format further indicates to skip monitoring the PDCCH for one or more subsequent monitoring occasions.

19. The BS of claim 15, wherein:
the indication is provided by a downlink control information (DCI) format in a physical downlink control channel (PDCCH), and
the second information provides separate search space configuration for transmitting the PDCCH during the active period and the inactive period of the cell DTX.

20. The BS of claim 15, wherein the one or more cell DTX configurations are associated with respective search space configurations for transmitting a physical downlink control channel (PDCCH) for a transmission of at least one of:
system information,
paging,
messages during random access, and
data.
